(19) United States
(12) Patent Application Publication
(10) Pub. No.: US 2018/0099399 A1
(43) Pub. Date: Apr. 12, 2018

(54) ELECTRIC POWER TOOL AND METHOD OF ASSEMBLING ELECTRIC POWER TOOL

(71) Applicant: MAKITA CORPORATION, Anjo-shi (JP)

(72) Inventors: Hikaru SUNABE, Anjo-shi (JP); Hirokatsu YAMAMOTO, Anjo-Shi (JP); Ryo UMEMOTO, Anjo-shi (JP)

(73) Assignee: MAKITA CORPORATION, Anjo-shi (JP)

(21) Appl. No.: 15/720,451

(22) Filed: Sep. 29, 2017

(30) Foreign Application Priority Data
Oct. 7, 2016 (JP) 2016-199176

(51) Int. Cl. B25F 5/02; B25D 17/04; B25F 5/00

(52) U.S. Cl. CPC B25F 5/02; B25D 17/04; B25F 5/006; B25D 2216/0023; B25D 2250/165; B25D 2250/221; B25D 2250/201

(57) ABSTRACT

An electric power tool in one aspect of the present disclosure includes a housing; a motor; an output shaft; a rotation transmission; a motor controller; and a twisted-motion detector. The twisted-motion detector is disposed in the housing independently from the motor controller. The twisted-motion detector detects a twisted-motion of the housing in the circumferential direction of the output shaft and outputs a result of the detection to the motor controller.

### CROSS-REFERENCE TO RELATED APPLICATIONS

This application claims the benefit of Japanese Patent Application No. 2016-199176 filed Oct. 7, 2016 in the Japan Patent Office, the disclosure of which is incorporated herein by reference.

### BACKGROUND

The present disclosure relates to an electric power tool.

Electric power tools disclosed in Japanese Unexamined Patent Application Publications 2004-518551 and 2013-244581 detect a locked-state, in which a tip tool cannot be controlled, by a device such as an acceleration sensor. These electric power tools stop the drive of a motor when the locked-state is detected. In these electric power tools, a sensor unit is configured integrally with a motor control unit.

### SUMMARY

In the aforementioned electric power tools, it may be difficult to place the sensor unit, which is configured integrally with the motor control unit, in the optimal location. In addition, it may also be difficult to effectively utilize the inner space (in other words, inside a housing) of these electric power tools.

More specifically, a twisted-motion of the housing may not be easily detected in these electric power tools. When a tip tool is jammed into a workpiece, a housing can typically be moved in a twisted motion in a circumferential direction of an output shaft. Detection of a twisted-motion of the housing can be facilitated by disposing the sensor unit to be spaced apart from the output shaft. In these electric power tools, it may nevertheless be difficult to dispose the sensor unit in a location spaced apart from the output shaft.

In one aspect of the present disclosure, it is desirable that components such as a detector for detecting a twisted-motion of a housing are disposed in a suitable location in the housing of an electric power tool.

An electric power tool in one aspect of the present disclosure includes a housing; a motor; an output shaft; a rotation transmission; a motor controller; and a twisted-motion detector. The motor is housed in the housing. The output shaft is housed in the housing and includes a first end for attachment to a tool bit. The rotation transmission is housed in the housing and transmits a rotation of the motor to the output shaft to rotate the output shaft in a circumferential direction of the output shaft. The motor controller is housed in the housing and controls drive of the motor in accordance with a command, inputted from outside the housing.

The twisted-motion detector is disposed in the housing independently from the motor controller. The twisted-motion detector detects a twisted-motion of the housing in the circumferential direction of the output shaft. The twisted-motion detector also outputs a result of the detection to the motor controller.

In this electric power tool, the twisted-motion detector can be disposed in a suitable location in the housing for detecting the twisted-motion of the housing, since it is independent from the motor controller. In this electric power tool, the size of the motor controller can be reduced by configuring the motor controller as a single unit. In addition, the motor controller in this electric power tool can be used as a common component for electric power tools with different specifications.

The twisted-motion detector may be disposed in a given location in the housing, for example, in a location where acceleration occurs due to the twisted-motion of the housing.

This configuration can reduce an increase in the size of the electric power tool (the size of the housing), compared with a configuration, in which a twisted-motion detector configured integrally with a motor controller is disposed in a suitable location for detecting the twisted-motion of the housing.

The given location may be spaced apart from the output shaft.

The housing may include a handle and a battery port. The handle is configured to be grasped by a user of the electric power tool, and disposed in a first end of the housing. The first end of the housing is situated opposite to the first end of the output shaft in an axial direction of the output shaft. The battery port is configured for attachment to a battery. The battery port is disposed in the housing such that the motor is situated in the housing between the battery port and the output shaft. The battery is configured to supply electric power for the motor. The motor controller may be disposed between the battery port and the handle.

A vibration caused by the drive of the motor is not easily transmitted to the handle and the battery port. Since the motor controller is situated between the handle and the battery port, vibration-induced damage of the motor controller may thus be reduced.

The aforementioned electric power tool may further include a hammer part and a load detector. The hammer part is housed in the housing. The hammer part moves the tool bit, attached to the output shaft, in a reciprocating motion in the axial direction of the output shaft through a rotation of the motor and causes the tool bit to hammer on the workpiece.

The load detector detects, based on a vibration of the housing, a load applied from the workpiece to the tool bit due to a hammering motion of the hammer part. The load detector also outputs a result of the detection to the motor controller. The hammer part and the load detector disposed in the electric power tool help enable the motor controller to execute a low-speed control at no load (hereinafter referred to as a soft-no-load control). In the soft-no-load control, the rotational speed of the motor is reduced when the tool bit is in a no-load state; the rotational speed of the motor is increased when the tool bit is in a loaded state.

The load detector may be configured integrally with the twisted-motion detector. The load detector may alternatively be disposed in the housing independently and separately from the twisted-motion detector.

The housing may include a vibrating section, and a vibration-insulated section. The load detector may be disposed in the vibrating section. The vibrating section houses the hammer part and vibrates in response to the drive of the motor. The vibration-insulated section receives a reduced vibration transmitted from the vibrating section. This configuration can help facilitate detection of vibration of the housing by the load detector and improve the precision of detection of a load on the tool bit.

The load detector may be rigidly coupled to the housing in the vibrating section. This configuration helps facilitate transmission of vibration of the housing to the load detector, and thus further improves the precision of the detection of a load on the tool bit. The load detector may be rigidly coupled to the housing with a component for coupling, such as a screw.

The load detector may include a casing having a shape that determines an assembly orientation of the load detector relative to the housing. This configuration helps reduce the incidence of the load detector being assembled in an incorrect orientation relative to the housing. Thus, a decrease in precision of detecting a load on the tool bit, resulting from such incidence of an incorrect assembly of the load detector, can be reduced.

The vibrating section may include a first side. The first side is situated opposite, across the motor, a side where the output shaft is disposed. The load detector may be disposed in the first side in the vibrating section. The vibrating section may alternatively include a second side. The second side is situated opposite, across the motor, a side where the first end of the output shaft is disposed. The load detector may be disposed in the second side in the vibrating section.

This configuration can help the load detector favorably detect a vibration of the housing. Moreover, this configuration can also facilitate the detection of the twisted-motion of the housing, by disposing the twisted-motion detector, which is configured integrally with the load detector, to be spaced apart from the output shaft.

If the load detector is disposed in the housing independently and to be spaced apart from the twisted-motion detector, and is situated in the vibrating section, then the twisted-motion detector may be disposed in the vibration-insulated section.

Another aspect of the present disclosure is a method of assembling an electric power tool. The method includes housing a motor in a housing of the electric power tool; housing an output shaft in the housing, the output shaft including a first end for attachment to a tool bit; housing a rotation transmission in the housing, the rotation transmission being configured to transmit a rotation of the motor to the output shaft to rotate the output shaft in a circumferential direction of the output shaft; housing a motor controller in the housing, the motor controller being configured to control the drive of the motor in accordance with a command, inputted from outside the housing; and disposing a twisted-motion detector in the housing independently from the motor controller, the twisted-motion detector being configured to detect a twisted-motion of the housing in the circumferential direction of the output shaft, and the twisted-motion detector further being configured to output a result of the detection to the motor controller.

With the aforementioned method, the twisted-motion detector can be disposed in a suitable location in the housing.

### BRIEF DESCRIPTION OF THE DRAWINGS

Example embodiments in the present disclosure will now be described with reference to the accompanying drawings, in which:

FIG. 1 is a cross sectional view showing a configuration of a hammer drill according to one embodiment;

FIG. 2 is a perspective view showing an external appearance of the hammer drill;

FIG. 3 is a view for explaining assembly of a twisted-motion detector to a motor housing;

FIG. 4 is a block diagram showing an electrical configuration of a driving system of the hammer drill;

FIG. 5 is a flow chart showing an acceleration-load detection process performed in an acceleration-detection circuit in the twisted-motion detector;

FIG. 6A is a flow chart showing a part of a twisted-motion detection process performed in the acceleration-detection circuit in the twisted-motion detector;

FIG. 6B is a flow chart showing the rest of the twisted-motion detection process;

FIG. 7 is a cross sectional view showing disposition of a twisted-motion detector in a hammer drill according to a modified embodiment;

FIG. 8 is a view for explaining assembly of the twisted-motion detector to a motor housing in the hammer drill according to the modified embodiment; and

FIG. 9 is a perspective view showing the assembled twisted-motion detector in the hammer drill according to the modified embodiment.

### DETAILED DESCRIPTION OF THE PREFERRED EMBODIMENTS

A hammer drill 2 in the present embodiment is configured to perform chipping work or drilling work on a workpiece (for example, on concrete) with a tool bit 4 such as a hammer bit, by moving the tool bit 4 in a hammering motion along the longitudinal axis of the tool bit 4, or in a rotational motion about the longitudinal axis of the tool bit 4, for example.

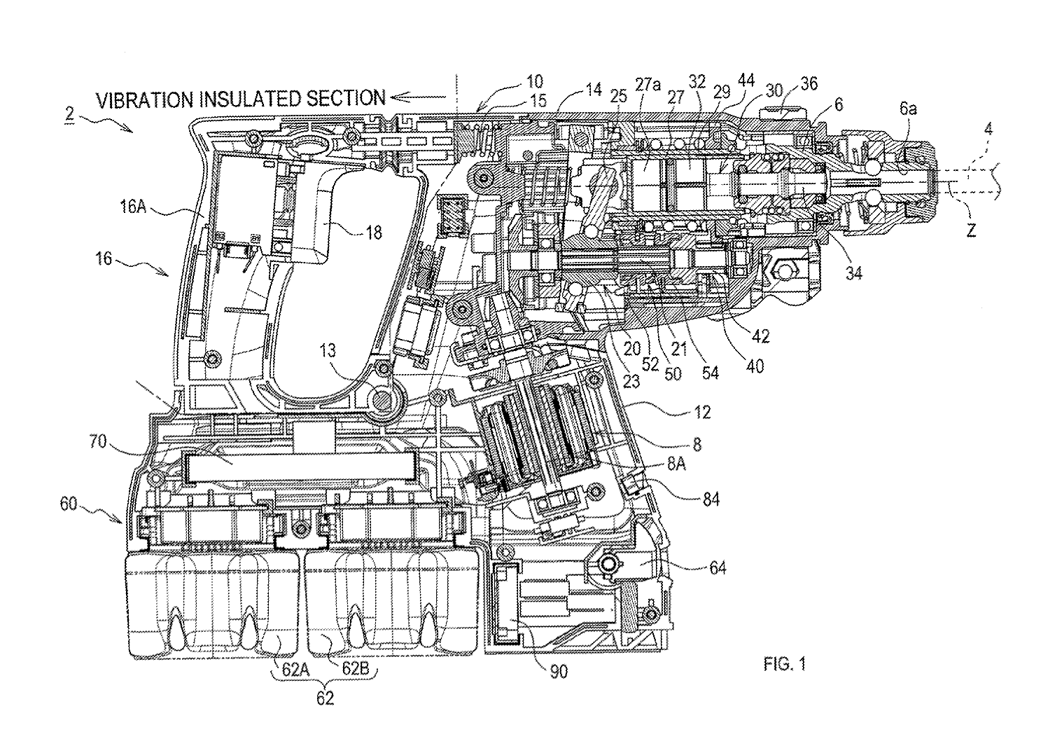

As shown in FIG. 1, the hammer drill 2 includes a main housing 10 that defines the outline of the hammer drill 2. At the tip area of the main housing 10, the tool bit 4 is detachably attached to the main housing 10 via a tool holder 6. The tool holder 6 has a tubular shape and functions as an output shaft.

The tool bit 4 is inserted through a bit hole 6a of the tool holder 6 and held by the tool holder 6. The tool bit 4 can be moved in a reciprocating motion, relative to the tool holder 6, along the longitudinal axis of the tool bit 4. A rotational motion of the tool bit 4, relative to the tool holder 6, about the longitudinal axis of the tool bit 4, is restricted.

The main housing 10 includes a motor-housing 12, and a gear-housing 14. The motor-housing 12 houses a motor 8. The gear-housing 14 houses a motion conversion mechanism 20, a hammering element 30, a rotation-transmission mechanism 40, and a mode-change mechanism 50.

A hand grip 16 is coupled to a side of the main housing 10, opposite the side where the tool holder 6 is disposed. The hand grip 16 includes a handle 16A that is grasped by an operator. The handle 16A extends towards a direction (vertical direction in FIG. 1) that crosses the longitudinal axis of the tool bit 4 (in other words, the central axis of the tool holder 6). A part of the handle 16A is on the extension line (the longitudinal axis) of the tool bit 4.

A first-end of the handle 16A (in other words, an end of the handle 16A located closely to the longitudinal axis of the tool bit 4) is coupled to the gear-housing 14. A second end of the handle 16A (in other words, an end of the handle 16A located away from the longitudinal axis of the tool bit 4) is coupled to the motor-housing 12.

The hand grip 16 is fixed to the motor-housing 12 such that the hand grip 16 can swing about a support shaft 13. The hand grip 16 and the gear-housing 14 are coupled to each other via a spring 15 that provides a vibration insulating function.

The spring 15 reduces a vibration occurred in the gear-housing 14 (in other words, in the main housing 10) due to the hammering motion of the tool bit 4. This results in reducing a vibration of the hand grip 16 relative to the main housing 10.

Hereinafter, the front side; the rear side; the upper side; and the lower side of the hammer drill 2 are defined as follows for the convenience of explanation. The front side is where the tool bit 4 is disposed in a longitudinal-axis direction, which is along the longitudinal axis of the tool bit 4; and the rear side is where the hand grip 16 is disposed in the longitudinal-axis direction. In a direction, which is orthogonal to the longitudinal-axis direction and which is the direction of extension of the handle 16A (in other words, the vertical direction in FIG. 1), the upper side is where a connecting part that couples the hand grip 16 to the gear-housing 14 is disposed; and the lower side is where a connecting part that couples the hand grip 16 to the motor-housing 12 is disposed.

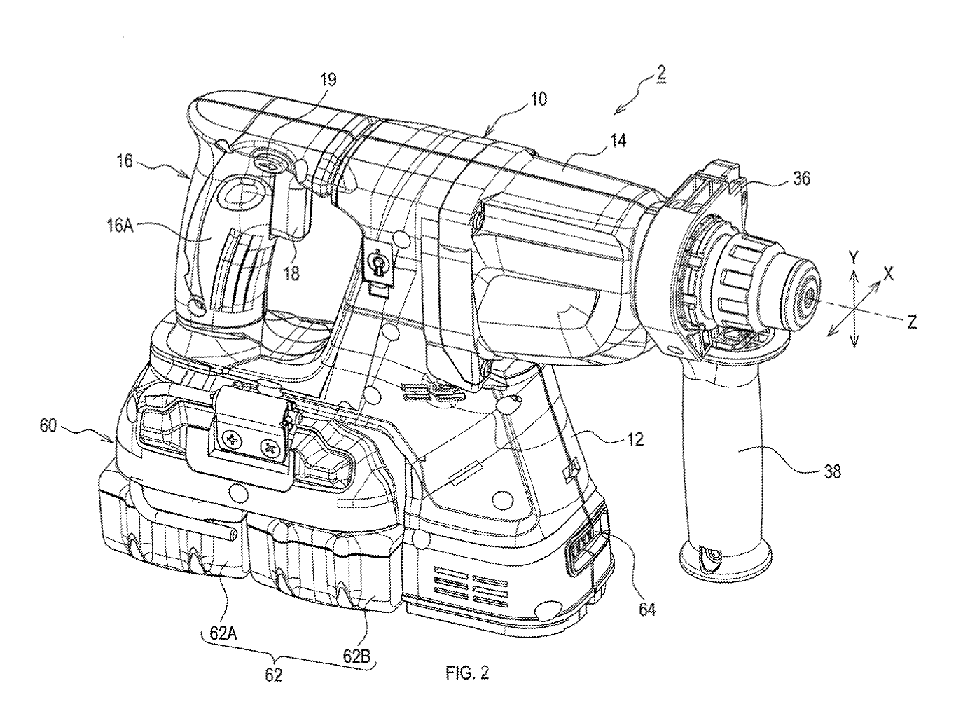

In addition, an axis along the longitudinal axis of the tool bit 4 (in other words, the central axis of the tool holder 6 that serves as an output shaft) is hereinafter defined as the Z-axis. An axis along the vertical direction of FIG. 1, which is orthogonal to the Z-axis, is hereinafter defined as the Y-axis. And, an axis along the horizontal direction, which is orthogonal to the Z-axis and Y-axis, (in other words, the width direction of the main housing 10) is hereinafter defined as the X-axis (see FIG. 2).

The gear-housing 14 is disposed in the front of the main housing 10. The motor-housing 12 is disposed below the gear-housing 14. The hand grip 16 is coupled to the rear side of the gear-housing 14.

Thus, in the hammer drill 2 in the present embodiment, the entire main housing 10 is a vibrating section, and the hand grip 16 is a vibration-insulated section. The main housing 10 includes the gear-housing 14, which is situated closer to the front side than the hand grip 16; and the motor-housing 12, which is disposed below the gear-housing 14.

In the present embodiment, the motor 8 that is housed in the motor-housing 12 is a brushless motor. Nevertheless, the motor 8 is not limited to a brushless motor in the present disclosure. The motor 8 is disposed such that a rotational shaft 8A of the motor 8 crosses the longitudinal axis of the tool bit 4 (in other words, the Z-axis). More specifically, the rotational shaft 8A extends in the vertical direction of the hammer drill 2.

As shown in FIG. 2, a retention grip 38 is attached around the outer circumference of a tip area of the gear-housing 14, from which the tool bit 4 protrudes, via a circular clamping member 36. In the same manner as the hand grip 16, the retention grip 38 is configured to be grasped by a user. More specifically, the user can grasp the hammer drill 2 by holding the hand grip 16 with one hand and the retention grip 38 with another hand.

An external device such as a dust collector is attached to the front side of the motor-housing 12. As shown in FIG. 1, and FIG. 2, a recess, in which the external device is fixed, is situated at the lower front side of the motor-housing 12 (more specifically, below the motor 8, and closer to the front side than the motor 8) so that the external device is attached to the motor-housing 12 (the hammer drill 2). A connector 64 is disposed inside the recess to electrically connect the external device to the hammer drill 2.

A twisted-motion detector 90 is housed in a lower part of the motor-housing 12 (more specifically, below the motor 8). The twisted-motion detector 90 detects that the main housing 10 is moved in a twisted motion as a result of jamming of the tool bit 4 in a workpiece when the tool bit 4 is rotated for a drilling work.

The twisted-motion detector 90 in the present embodiment also functions as a load detector that detects, based on a vibration state of the main housing 10, whether a load is applied from the workpiece to the tool bit 4 due to the hammering motion of the tool bit 4.

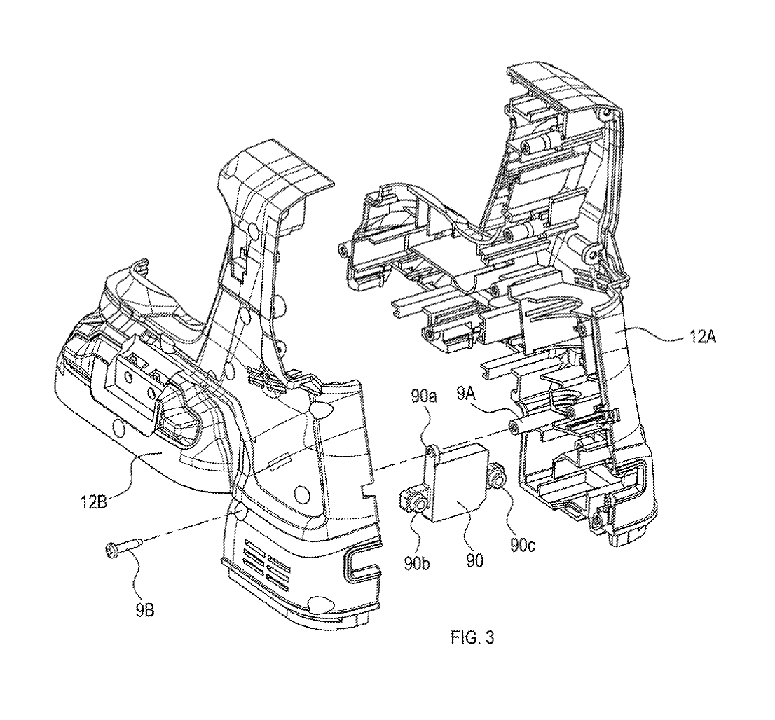

As shown in FIG. 3, the twisted-motion detector 90 is directly fixed to the motor-housing 12 with a screw 9B to facilitate transmission of the vibration of the main housing 10.

More specifically, the motor-housing 12 is configured to be separable into a housing portion 12A and a housing portion 12B, at the rotational shaft 8A of the motor 8 that is housed inside the motor-housing 12.

The housing portion 12A, one of the separated motor-housing 12, includes a supporting rod 9A. The supporting rod 9A is configured to protrude from an inner side of the housing portion 12A and reach inside the housing portion 12B, the other one of the separated motor-housing 12. The supporting rod 9A is configured to be coupled to the housing portion 12B and is also configured to fix a casing of the twisted-motion detector 90. The housing portion 12B is configured so that the screw 9B, which is inserted from the outer surface of the housing portion 12B towards an inner side of the housing portion 12B, can be screwed into a threaded hole in the supporting rod 9A.

The casing of the twisted-motion detector 90 includes an attachment 90a. When the housing portion 12A and the housing portion 12B is coupled together with the screw 9B, the attachment 90a is configured to be interposed between the head of the supporting rod 9A and an inner wall of the housing portion 12B so as to be tightly fixed with the screw 9B.

The attachment 90a includes a through hole for the screw 9B to pass through. The twisted-motion detector 90 is fixed directly inside the motor-housing 12 with the screw 9B via the attachment 90a. Accordingly, the twisted-motion detector 90 is rigidly coupled to the main housing 10. The vibration of the main housing 10 is thus directly transmitted to the twisted-motion detector 90.

The twisted-motion detector 90 includes a rectangular box-shaped casing. The supporting rod 9A is configured so that the head of the supporting rod 9A protrudes to reach inside the housing portion 12B. The attachment 90a is disposed on the upper surface of the casing, in a location that is displaced from the center of the casing in the horizontal direction towards the housing portion 12B. The casing of the twisted-motion detector 90 includes a cut at a corner. The attachment 90a and the cut are situated in diagonally opposite corners of the casing.

The position of the attachment 90a and the cut determine the assembly orientation of the twisted-motion detector 90 relative to the motor-housing 12. The incidence of the twisted-motion detector 90 being assembled in an incorrect orientation relative to the motor-housing 12 is thereby reduced.

It is accordingly possible to reduce a decrease in precision of detecting a twisted-motion of the main housing 10 and a loaded state of the tool bit 4, resulting from assembling the twisted-motion detector 90 in an incorrect orientation.

As shown in FIG. 3, the casing of the twisted-motion detector 90 includes, respectively on its left side and right side, an attachment 90b, and an attachment 90c for screw-fixing. The attachments 90b and 90c serve to fix the casing to a hammer drill with a different specification, such as a hammer drill in the modified example that will be mentioned hereinafter.

Each of the attachments 90b and 90c is disposed on the casing in a location that is displaced from the center of the casing in the vertical direction towards the lower side of the casing. Similarly to the attachment 90a, the attachments 90b and 90c determine the assembly orientation of the twisted-motion detector 90. When the twisted-motion detector 90 is fixed to the housing, the attachments 90b and 90c serve to prevent the twisted-motion detector 90 from being assembled in an incorrect orientation relative to the housing by the operator.

Two battery packs 62A and 62B, which are power source for the hammer drill 2, are situated closer to the rear side than a housing area for the twisted-motion detector 90. The battery packs 62A and 62B are detachably attached to a battery port 60 that is disposed in the lower side of the motor-housing 12.

The battery port 60 is disposed above the level of the lower-end surface of the housing area for the twisted-motion detector 90 (in other words, the base of the motor-housing 12). The lower-end surfaces of the battery packs 62A and 62B, attached to the battery port 60, are aligned with the lower-end surface of the housing area for the twisted-motion detector 90.

A motor controller 70 is disposed above the battery port 60 (in other words, below the hand grip 16) in the motor-housing 12. The motor controller 70 receives electric power from the battery packs 62A and 62B and controls the drive of the motor 8.

The rotation of the rotational shaft 8A of the motor 8 is converted into a straight-line movement by the motion conversion mechanism 20 and transmitted to the hammering element 30. The hammering element 30 generates an impact force in the longitudinal-axis direction of the tool bit 4. The rotation of the rotational shaft 8A of the motor 8 is decelerated by the rotation-transmission mechanism 40 and then transmitted to the tool bit 4. The tool bit 4 is accordingly rotationally driven about its longitudinal axis. The motor 8 is driven in accordance with a pull-action on a trigger 18 that is disposed on the hand grip 16.

As shown in FIG. 1, the motion conversion mechanism 20 is disposed above the rotational shaft 8A of the motor 8.

The motion conversion mechanism 20 includes an intermediate shaft 21; a rotating body 23; a swinging member 25; a piston 27; and a cylinder 29. The intermediate shaft 21 is disposed so as to cross the rotational shaft 8A and is rotationally driven by the rotational shaft 8A. The rotating body 23 is attached to the intermediate shaft 21. The swinging member 25 is caused to move in a swinging motion in accordance with a rotation of the intermediate shaft 21 (the rotating body 23) in a front-rear direction of the hammer drill 2. The piston 27 is a cylindrical member and includes a closed bottom. The piston 27 houses a striker 32, which will be mentioned hereinafter, so that the striker 32 is slidable. The piston 27 moves in a reciprocating motion in the front-rear direction of the hammer drill 2 along with the swinging motion of the swinging member 25.

The cylinder 29 is integrally formed with the tool holder 6. The cylinder 29 houses the piston 27 and also configures a rear region of the tool holder 6 and.

As shown in FIG. 1, the hammering element 30 is disposed closer to the front side than the motion conversion mechanism 20 and closer to the rear side than the tool holder 6. The hammering element 30 includes the aforementioned striker 32 and an impact bolt 34. The striker 32 functions as a hammer and strikes the impact bolt 34 that is disposed closer to the front side than the striker 32.

The piston 27, which is situated closer to the rear side than the striker 32, includes an inner space that forms an air chamber 27a. The air chamber 27a functions as an air spring. Due to this air spring function, the swinging motion of the swinging member 25 in the front-rear direction of the hammer drill 2 causes the piston 27 to move in a reciprocating motion in the front-rear direction of the hammer drill 2, which accordingly drives the striker 32.

More specifically, a forward movement of the piston 27 causes the striker 32 to move forward by the effect of the air spring and strike the impact bolt 34. The impact bolt 34 is accordingly moved forward and strikes the tool bit 4. Consequently, the tool bit 4 hammers the workpiece.

In addition, a rearward movement of the piston 27 moves the striker 32 rearward and thus creates a positive pressure in the air chamber 27a compared to the atmosphere. A reaction force in response to the tool bit 4 hammering the workpiece also causes the striker 32 and the impact bolt 34 to move rearward.

The striker 32 and the impact bolt 34 are thus moved in a reciprocating motion in the front-rear direction of the hammer drill 2. Since the striker 32 and the impact bolt 34 are driven by the effect of the air spring of the air chamber 27a, their movements in the front-rear direction are delayed from the front-rear movement of the piston 27.

As shown in FIG. 1, the rotation-transmission mechanism 40 is situated closer to the front than the motion conversion mechanism 20 and below the hammering element 30. The rotation-transmission mechanism 40 includes a gear-deceleration mechanism. The gear-deceleration mechanism includes gears, including a first gear 42 that rotates with the intermediate shaft 21; and a second gear 44 that meshes with the first gear 42.

The second gear 44 is connected to the tool holder 6 (more specifically, the cylinder 29), and transmits the rotation of the first gear 42 to the tool holder 6. The tool bit 4, held by the tool holder 6, is thereby rotated. The rotation of the output shaft 8A of the motor 8 is decelerated by a first bevel gear and a second bevel gear, in addition to the rotation-transmission mechanism 40. The first bevel gear is disposed at a tip of the output shaft 8A; and the second bevel gear is disposed at the rear end of the intermediate shaft 21 and meshes with the first bevel gear.

The hammer drill 2 in the present embodiment includes three drive modes that include hammer mode; hammer-drill mode; and drill mode.

In the hammer mode, the tool bit 4 performs a hammering motion along the longitudinal-axis direction and hammers the workpiece. In the hammer-drill mode, the tool bit 4 moves in a rotational motion about the longitudinal axis, in addition to the hammering motion, and drills a hole in the workpiece while hammering the workpiece. In the drill mode, the tool bit 4 performs only the rotational motion to drill a hole in the workpiece, without performing the hammering motion.

The drive mode can be switched by the mode-change mechanism 50. The mode-change mechanism 50 is configured mainly with rotation-transmission members 52 and 54 as shown in FIG. 1; and a selector dial (not shown) disposed on the left-side surface of the hammer drill 2.

The rotation-transmission members 52 and 54 are substantially cylindrical members and can move along the intermediate shaft 21. The rotation-transmission members 52 and 54 are splined to the intermediate shaft 21 and rotate integrally with the intermediate shaft 21.

The rotation-transmission member 52 moves to the rear side of the intermediate shaft 21 to engage with an engaging groove, which is formed at the front side of the rotating body 23, and transmits the rotation of the motor 8 to the rotating body 23. The drive mode of the hammer drill 2 is consequently set to the hammer mode or the hammer-drill mode.

The rotation-transmission member 54 moves to the front side of the intermediate shaft 21 to engage with the first gear 42 and transmits the rotation of the motor 8 to the first gear 42. The drive mode of the hammer drill 2 is consequently set to the hammer-drill mode or the drill mode.

The selector dial displaces the rotation-transmission members 52 and 54 on the intermediate shaft 21 in response to the rotation of the selector dial by the user. The selector dial is rotated to one of three positions, which respectively set the drive mode of the hammer drill 2 to the hammer mode, the hammer-drill mode, or the drill mode.

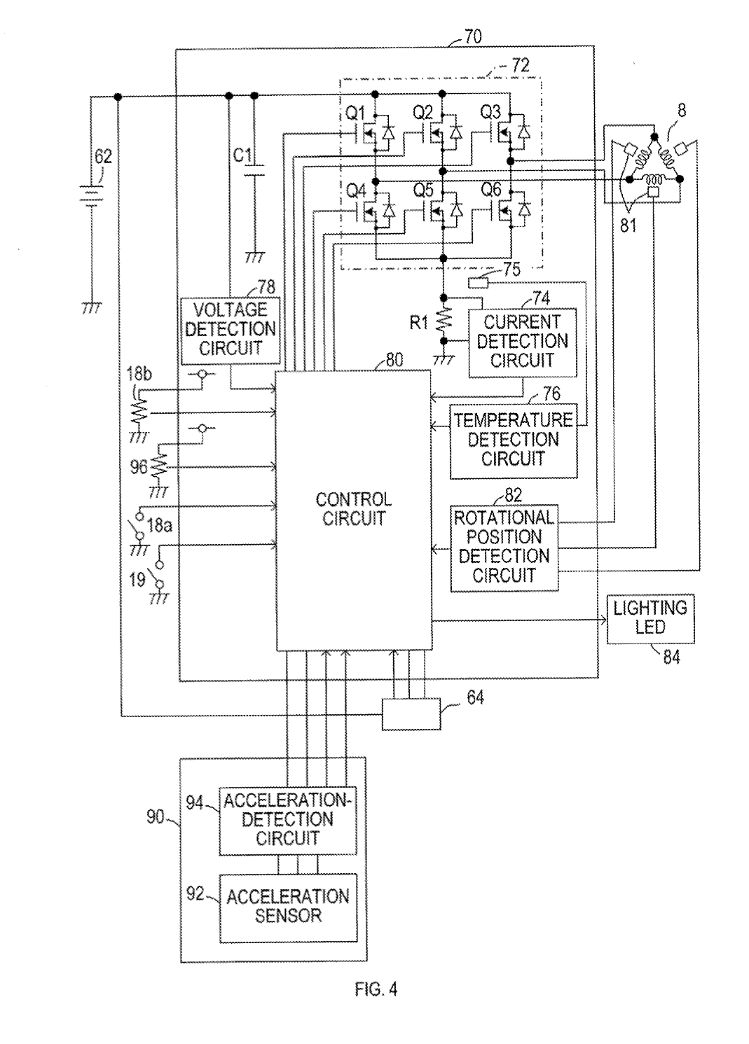

Configuration of the motor controller 70 and the twisted-motion detector 90 will be explained next with reference to FIG. 4. The motor controller 70 and the twisted-motion detector 90 are mounted on separate circuit boards and are housed in separate casings. The twisted-motion detector 90 includes an acceleration sensor 92 and an acceleration-detection circuit 94. The acceleration sensor 92 detects accelerations (more specifically, values of accelerations) in three axial directions (that is, along X-axis; Y-axis; and Z-axis). The acceleration-detection circuit 94 processes a detection signal from the acceleration sensor 92 and detects that the main housing 10 is moved in a twisted-motion.

More specifically, the acceleration-detection circuit 94 includes a Micro Controller Unit (MCU) that includes a CPU, a ROM, and a RAM. The acceleration-detection circuit 94 performs a twisted-motion detection process, which will be mentioned hereinafter, in which the acceleration-detection circuit 94 detects that the main housing 10 is moved in a twisted-motion by a given degree or more about the Z-axis (that is, the longitudinal axis of the tool bit 4), based on the detection signal (more specifically, an output based on the acceleration in the X-axis direction) from the acceleration sensor 92.

The acceleration-detection circuit 94 further performs an acceleration-load detection process, in which the acceleration-detection circuit 94 uses the acceleration sensor 92 to detect vibrations (more specifically, magnitude of vibrations) of the main housing 10 in the three axial directions that are occurred due to the hammering motion of the tool bit 4. In the acceleration-load detection process, the acceleration-detection circuit 94 detects that a load is applied on the tool bit 4 when at least one of the vibrations (in other words, the acceleration) of the main housing 10 exceed a threshold value. In the acceleration-load detection process, the twisted-motion detector 90 serves its function as a load detector.

The motor controller 70 includes a drive circuit 72 and a control circuit 80.

The drive circuit 72 includes switching elements Q1 to Q6. The drive circuit 72 is configured to receive electric power from a battery pack 62 (more specifically, the battery packs 62A and 62B connected in series), and deliver electric current to phase windings of the motor 8 (more specifically, a three-phase brushless motor). Each of the switching elements Q1 to Q6 in the present embodiment is an FET; nevertheless, the switching element in the present disclosure is not limited to FETs. In alternative embodiments, each of the switching elements Q1 to Q6 may be any switching element other than a FET.

Each of the switching elements Q1 to Q3 is disposed, as a so-called high-side switch, between a respective terminal (U, V, or W) of the motor 8 and a power supply line. The power supply line is coupled to the positive electrode of the battery pack 62.

Each of the switching elements Q4 to Q6 is disposed, as a so-called low-side switch, between a respective terminal (U, V, or W) of the motor 8 and a ground line. The ground line is coupled to the negative electrode of the battery pack 62.

A capacitor C1 is disposed on the electric-power supply path from the battery pack 62 to the drive circuit 72. The capacitor C1 serves to reduce variations in the battery voltage.

Similar to the acceleration-detection circuit 94, the control circuit 80 includes an MCU that includes a CPU; a ROM; and a RAM. The control circuit 80 delivers electric current to the phase windings of the motor 8 by turning the switching elements Q1 to Q6 in the drive circuit 72 on and off and rotates the motor 8.

More specifically, the control circuit 80 sets a commanding rotational speed for the motor 8 and a rotational direction of the motor 8 to control the drive of the motor 8 in accordance with commands from a trigger switch 18a; a speed-change commanding device 18b; an upper-speed-limit setting device 96; and a rotational-direction setting device 19.

The trigger switch 18a is configured to be turned on in response to a pull-action on the trigger 18 and transmit a command for driving the motor 8 to the control circuit 80. The speed-change commanding device 18b is configured to change the commanding rotational speed in accordance with the pull amount of the trigger 18 (in other words, the proportion pulled) by generating a signal in accordance with the pull amount.

The upper-speed-limit setting device 96 includes a dial (not shown). The dial is turned in a stepwise manner by the user of the hammer drill 2 to switch dial positions. The upper-speed-limit setting device 96 is configured to set an upper limit of the rotational speed of the motor 8 in accordance with the dial positions.

More specifically, the upper-speed-limit setting device 96 is configured so that the upper limit of the rotational speed of the motor 8 can be set between a rotational speed higher than a no-load rotational speed, which is set in the soft-no-load control, and a rotational speed lower than the no-load rotational speed.

The soft-no-load control is for controlling the rotational speed of the motor 8 at a specified no-load rotational speed or lower, when a no-load state is detected in the acceleration-load detection process performed in the acceleration-detection circuit 94; and no-load drive of the motor 8 is detected based on the electric current conducted through the motor 8. The soft-no-load control is one of control processes performed by the control circuit 80.

The rotational-direction setting device 19 is configured to set the rotational direction of the motor 8 to a normal direction or to a reverse direction in response to the user switching the rotational-direction setting device 19. As shown in FIG. 2, the rotational-direction setting device 19 is disposed above the trigger 18 in the present embodiment. A rotation of the motor 8 in the normal direction enables the hammer drill 2 to perform a drilling work on the workpiece.

The control circuit 80 sets the commanding rotational speed for the motor 8, based on the signal from the speed-change commanding device 18b, and the upper limit of the rotational speed, set by the upper-speed-limit setting device 96. More specifically, the control circuit 80 sets the commanding rotational speed in accordance with the pull amount (the proportion pulled) of the trigger 18, so that the rotational speed of the motor 8 reaches the upper limit of the rotational speed, which is set by the upper-speed-limit setting device 96 when the trigger 18 is fully pulled.

The control circuit 80 sets a duty ratio for driving the switching elements Q1 to Q6 in accordance with the set commanding rotational speed and rotational direction. The control circuit 80 then outputs a control signal, which is generated in accordance with the duty ratio, to the drive circuit 72, and rotationally drives the motor 8.

In the front side of the motor-housing 12, an LED 84 (hereinafter, referred to as “LED lighting 84”), which serves as a lighting, is disposed. The control circuit 80 turns the LED lighting 84 on to illuminate a working area of the tool bit 4 on the workpiece, when the trigger switch 18a is placed in an on-state.

The motor 8 includes a rotational-position sensor 81. The rotational-position sensor 81 detects the rotational speed of the motor 8, and the rotational position of the motor 8 (more specifically, the rotational position of a rotor of the motor 8), and outputs a detection signal to the motor controller 70. The motor controller 70 includes a rotational-position detection circuit 82. The rotational-position detection circuit 82 detects the rotational position of the motor 8 based on the detection signal from the rotational-position sensor 81.

The motor controller 70 further includes a voltage detection circuit 78; an electric-current detection circuit 74; and a temperature detection circuit 76, in addition to the rotational-position detection circuit 82. Detection signals from each of these detection circuits and detection signals from the twisted-motion detector 90 are inputted to the control circuit 80.

The control circuit 80 either limits the rotational speed of the motor 8, which is being driven, or stops the drive of the motor 8 in accordance with the detection signals from the aforementioned detection circuits.

The voltage detection circuit 78 detects the value of the battery voltage supplied from the battery pack 62. The electric-current detection circuit 74 detects the value of the electric current that is delivered to the motor 8 via a resistor R1, which is disposed in the current path to the motor 8.

The temperature detection circuit 76 detects the temperature of the motor controller 70. The rotational-position detection circuit 82 detects the position of the rotor, which is necessary for setting the timing of completing the current path to each of the phase windings of the motor 8, based on the detection signal from the rotational-position sensor 81.

The motor controller 70 includes a regulator (not shown) that receives electric power from the battery pack 62 and generates a constant power supply voltage Vcc.

The power supply voltage Vcc, generated by the aforementioned regulator, is supplied to the MCU in the control circuit 80 and to the acceleration-detection circuit 94 in the twisted-motion detector 90. The acceleration-detection circuit 94 then outputs an error signal to the control circuit 80 when it detects the twisted-motion of the main housing 10 according to the acceleration in the X-axis direction.

The aforementioned error signal is outputted to the control circuit 80 in the motor controller 70 in order to stop the drive of the motor 8. The control circuit 80 stops the drive of the motor 80 in response to receiving the error signal. When the main housing 10 is not moved in a twisted-motion, the acceleration-detection circuit 94 outputs an non-error signal to the control circuit 80.

The acceleration-detection circuit 94 outputs a load-signal to the control circuit 80 when it detects a load on the tool bit 4 based on the vibration (in other words, the acceleration) of the main housing 10. The load-signal indicates that the tool bit 4 is in the loaded state.

The acceleration-detection circuit 94 outputs a no-load signal to the control circuit 80 when it does not detect a load on the tool bit 4. The no-load signal indicates that the tool bit 4 is in the no-load state.

The load-signal and the no-load signal are used when the control circuit 80 in the motor controller 70 performs the above-described soft-no-load control.

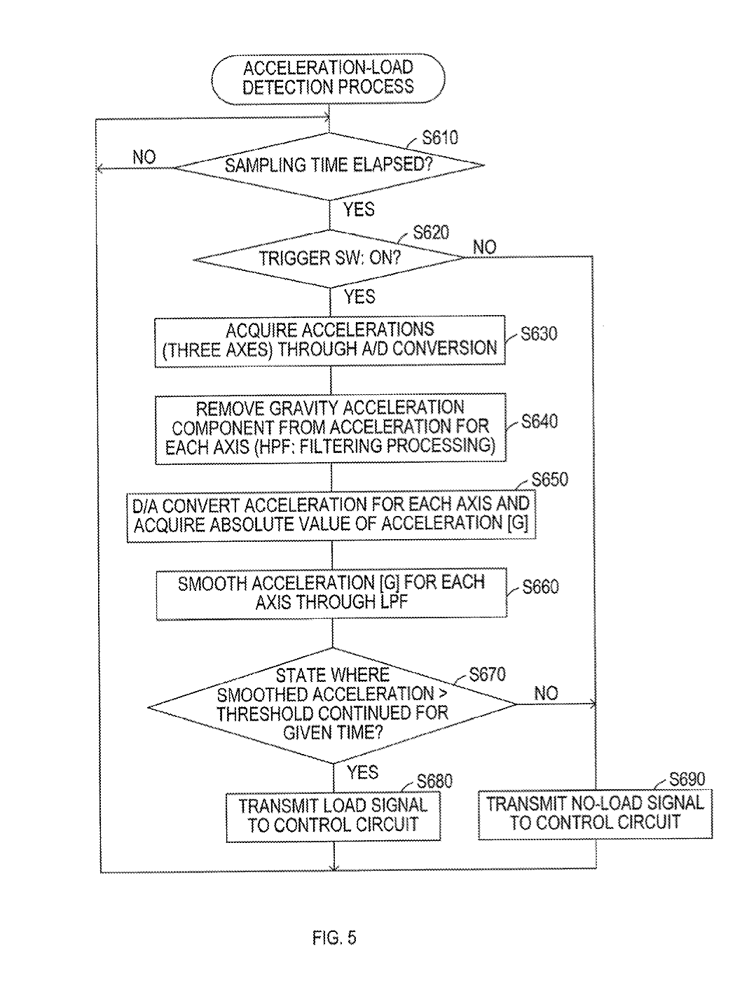

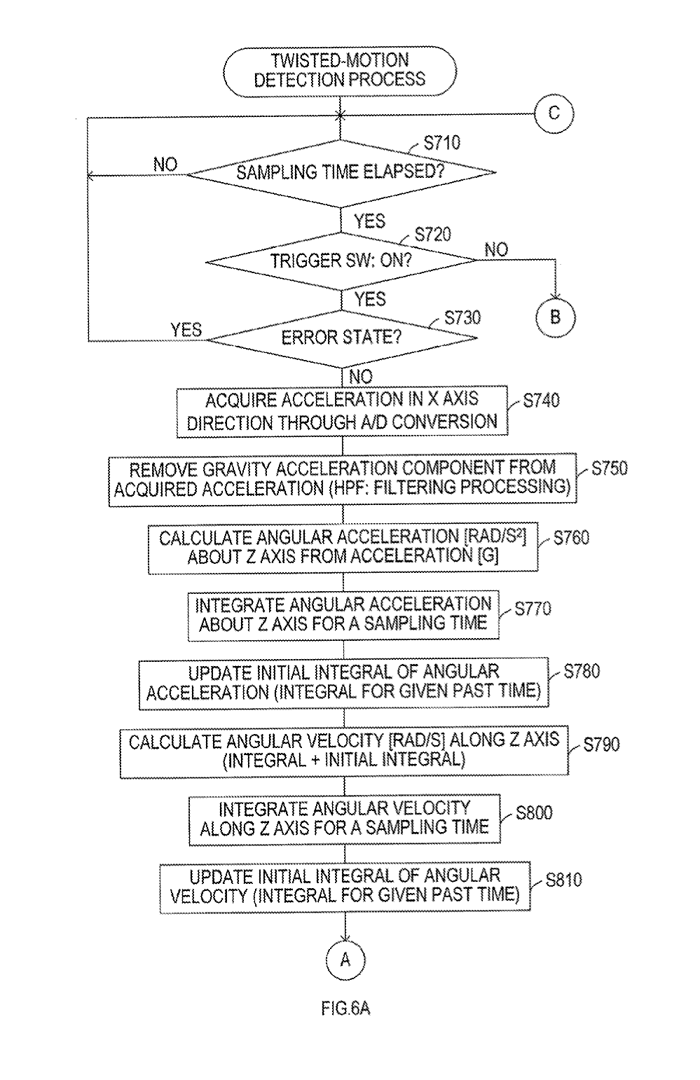

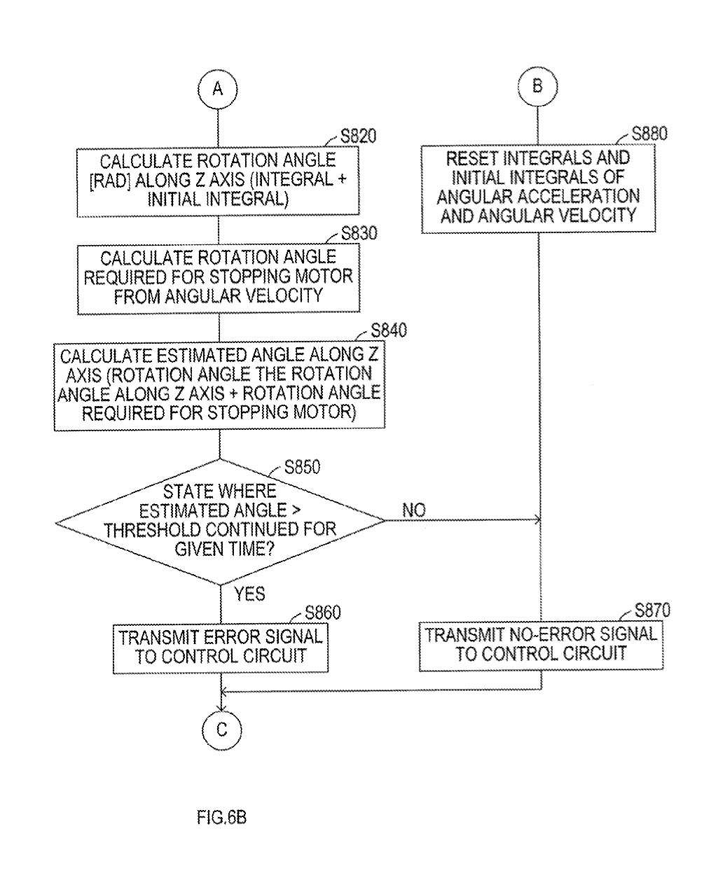

The acceleration-load detection process and the twisted-motion detection process, performed in the acceleration-detection circuit 94 in the twisted-motion detector 90, will be explained next with reference to the flowcharts in FIG. 5, FIG. 6A, and FIG. 6B.

In the acceleration-load detection process as shown in FIG. 5, the process determines, in S610 (S stands for step), whether a preset sampling time, which is set for determining whether a load is applied on the tool bit 4, has elapsed since the last process initiated S620. The process waits until the preset sampling time elapses.

If it is determined in S610 that the sampling time has elapsed, the process proceeds to S620. In S620, the process determines whether the trigger switch 18a is placed in the on-state (in other words, whether the user has inputted a command for driving the motor 8).

If it is determined in S620 that the trigger switch 18a is placed in the on-state, the process proceeds to S630. In S630, the process obtains acceleration data in the three axial directions (that is, along X-axis; Y-axis; and Z-axis) from the acceleration sensor 92 by converting the acceleration data from analog to digital (A/D conversion). In S640, the process removes gravity acceleration components from the obtained acceleration data in each axial direction by a filtering process.

Since this filtering process in S640 is for eliminating gravity acceleration components, it serves a function of a high-path filter (HPF) with cutoff frequency between around 1 to 10 Hz to remove low-frequency components, which represent the gravity acceleration.

The process proceeds to S650 after the acceleration data in each of the three axial directions is filtered in the filtering process in S640. In S650, the process converts the filtered acceleration data from digital to analog (D/A conversion), and obtains an absolute value of the acceleration [G] by, for example, full-wave rectifying the acceleration signal after the D/A conversion.

In S660, the process obtains smoothed acceleration by smoothing the absolute value of the acceleration [G] in each of the three axial directions, obtained in S650, by filtering with a low-path filter (LPF). The process then proceeds to S670.

In S670, the process compares the smoothed acceleration in each axis with a preset threshold value, which is set for determining the presence of a load. The process determines whether the smoothed acceleration in any one of the three axes continuously exceeds the threshold value for a given length of time or longer.

If it is determined in S670 that the smoothed acceleration in one of the three axes continuously exceeds the threshold value for the given length of time or longer, the process determines that the tool bit 4 is in the loaded state and proceeds to S680. In S680, the process outputs the load-signal, which indicates that the tool bit 4 is in the loaded state, to the control circuit 80, and proceeds to S610.

The process proceeds to S690 if it is determined in S670 that the smoothed acceleration in any one of the three axes is not continuously exceeding the threshold value for the given length of time or longer, or, if it is determined in S620 that the trigger switch 18a is placed in an off-state.

In S690, the process outputs the no-load signal to the control circuit 80 to notify the control circuit 80 that the tool bit 4 is in the no-load state and proceeds to S610.

Accordingly, the control circuit 80 is enabled to determine whether the loaded state (acceleration load) of the tool bit 4 is detected by obtaining the load-signal or the no-load signal outputted from the acceleration-detection circuit 94.

In the twisted-motion detection process as shown in FIG. 6A, the process determines, in S710, whether a preset sampling time, which is set for detecting the twisted-motion, has elapsed since last process initiated S720. The process waits until the preset sampling time elapses.

If it is determined in S710 that the sampling time has elapsed, the process proceeds to S720. In S720, the process determines whether the trigger switch 18a is placed in the on-state. The process proceeds to S730 if it is determined that the trigger switch 18a is placed in the on-state.

In S730, the process determines whether the twisted-motion of the hammer drill 2 is detected in the twisted-motion detection process and the hammer drill 2 is in an error state. The process proceeds to S710 if the process determines that the hammer drill 2 is in the error state; the process proceeds to S740 if the process determines that the hammer drill 2 is not in the error state.

In S740, the process obtains acceleration data in the X-axis direction from the acceleration sensor 92 by converting the acceleration data from analog to digital. In S750, similar to the above-described S640, the process removes gravity acceleration components from the obtained acceleration data in the X-axis direction by a filtering process, which serves a function of an HPF.

In S760, the process calculates angular acceleration [rad/s²] about the Z-axis from the filtered acceleration data (of acceleration [G]) in the X-axis direction, by the following formula: “angular acceleration=acceleration G×9.8/distance L”. In this formula, the distance L is the distance between the acceleration sensor 92 and the Z-axis. The process then proceeds to S770.

In S770, the angular acceleration, calculated in S760, is integrated for one sampling time. In S780, the process updates an initial value for integration of the angular acceleration. This initial value for integration is the integral of the angular acceleration within a given length of time in the past. Thus, in S780, since the latest angular acceleration is calculated in S760, the integral of the angular acceleration for one sampling time, obtained at or prior to a given time point, is deducted from the initial value for integration of the angular acceleration.

In S790, the process calculates an angular speed [rad/s] about the Z-axis by adding the initial value for integration of the angular acceleration, updated in S780, to the integral of the latest angular acceleration, calculated in S770.

In S800, the angular speed, calculated in S790, is integrated for one sampling time. In S810, the process updates an initial value for integration of the angular speed. This initial value for integration is the integral of the angular speed within a given length of time in the past. Thus, in S810, since the latest angular speed is calculated in S790, the integral of the angular speed for one sampling time, obtained at or prior to a given time point, is deducted from the initial value for integration of the angular speed.

In S820, the process calculates the first angle of rotation [rad] of the hammer drill 2 about the Z-axis, by adding the initial value for integration of the angular speed, updated in S810, to the integral of the latest angular speed, calculated in S800.

In S830, the process calculates the second angle of rotation of the hammer drill 2, for the distance the hammer drill 2 is rotated since the drive control of the motor 8 is stopped until the motor 8 actually stops, by using the latest angular speed, calculated in S790. The process then proceeds to S840. The angle of rotation is calculated by multiplying the angular speed by a preset estimated period of time: (angle of rotation=angular speed×estimated period of time).

In S840, the process calculates an estimated angle, which is the angle of rotation of the hammer drill 2 about the Z-axis including the angle of rotation after the drive control of the motor 8 is stopped (the second angle of rotation). For this calculation, the process adds the second angle of rotation of the hammer drill 2 about the Z-axis, calculated in S830, to the first angle of rotation of the hammer drill 2, calculated in S820.

In S850, the process determines whether the estimated angle, calculated in S840, exceeds a threshold value that is a preset angle for detecting the twisted-motion and whether the estimated angle continuously exceeds the threshold value for a given length of time or longer.

If the determination is positive in S850, then the process proceeds to S860. In S860, the process outputs the error signal to the control circuit 80 to notify the control circuit 80 that the tool bit 4 has jammed into the workpiece during the drilling work, and that the twisted-motion of the hammer drill 2 has started. The process then proceeds to S710.

Accordingly, the control circuit 80 determines that a motor-drive condition is not satisfied and stops the drive of the motor 8. The twisted-motion of the hammer drill 2 can thus be reduced.

If the determination is negative in S850, the process proceeds to S870. In S870, the process outputs the non-error signal to the control circuit 80 to notify the control circuit 80 that the hammer drill 2 is not moved in the twisted-motion. The process then proceeds to S710.

If it is determined in S720 that the trigger switch 18a is not placed in the on-state, the hammer drill 2 is stopped. The process thus proceeds to S880. In S880, the process resets the integral and the initial value for integration of the angular acceleration, and the integral and the initial value for integration of the angular speed. The process then proceeds to S870.

As explained hereinbefore, in the hammer drill 2 in the present embodiment, the twisted-motion detector 90 serves as a load detector in the present disclosure, in addition to serving its primary function as the twisted-motion detector, by having the acceleration-detection circuit 94 perform the acceleration-load detection process shown in FIG. 5 and the twisted-motion detection process shown in FIG. 6A and FIG. 6B.

The twisted-motion detector 90 is configured independently from the motor controller 70 and is fixed by the screw 9B directly to the lower side of the motor-housing 12. The lower side of the motor-housing 12 is the most distant area from the central axis (Z-axis) of the tool holder 6, which is the output shaft, in the main housing 10.

Accordingly, the hammer drill 2 is configured so that the twisted-motion detector 90 can be disposed in a location suitable for detecting the twisted-motion of the main housing 10, by utilizing the space in the lower side of the motor-housing 12.

Since the motor-housing 12 is the vibrating section, the twisted-motion detector 90 directly receives the vibration of the main housing 10. The acceleration-detection circuit 94 in the twisted-motion detector 90, which performs the acceleration-load detection process, is thus enabled to accurately detect a load on the tool bit 4.

The motor controller 70 is configured independently from the twisted-motion detector 90 and is disposed between the battery port 60 and the hand grip 16. This disposition of the motor controller 70 leads to easy electrical wiring between the motor controller 70 and each of the battery pack 62, motor 8, and trigger switch 18a.

Although an embodiment of the present disclosure has been described herein, the present disclosure may be modified and embodied in various other forms without being limited to the aforementioned embodiment.

For example, in the aforementioned embodiment, an example was given with respect to the hammer drill 2, in which a part of the motor-housing 12 configures the battery port 60, and the hand grip 16 is disposed above the battery port 60.

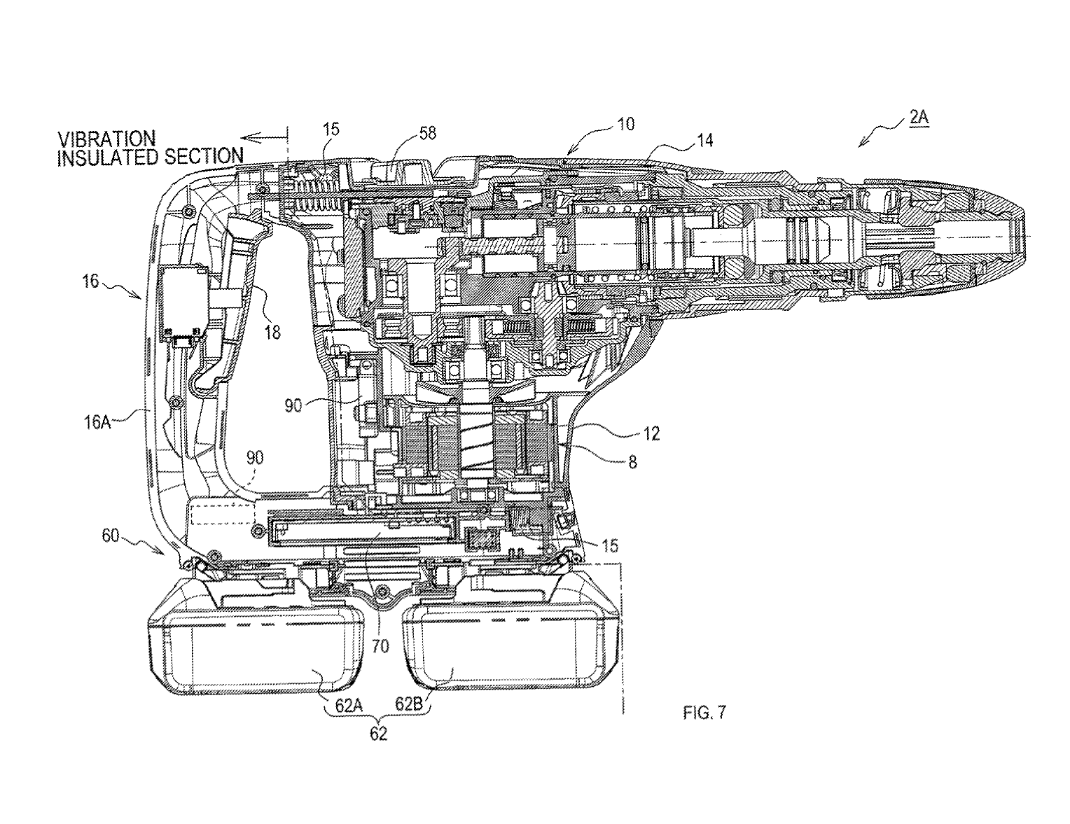

As shown in a hammer drill 2A in FIG. 7, the twisted-motion detector 90 may alternatively be disposed closer to the rear side than the motor 8. In the hammer drill 2A, the battery port 60 configures a part of the hand grip 16; and the motor-housing 12 is disposed above the front side of the battery port 60.

In the hammer drill 2A, not only the upper side of the hand grip 16 but also the battery port 60 at the lower side of the hand grip 16 is coupled to the main housing 10 (more specifically, the gear-housing 14, and the motor-housing 12) via the spring 15 that provides a vibration insulating function.

The battery port 60 is thus disposed in the vibration-insulated section;

and the motor 8 in the motor-housing 12 is disposed above the battery port 60. The twisted-motion detector 90 is thus disposed in a space closer to the rear side than the motor 8, which is the most distant space from the output shaft (Z-axis) in the motor-housing 12, so that the detection of the twisted-motion becomes easier.

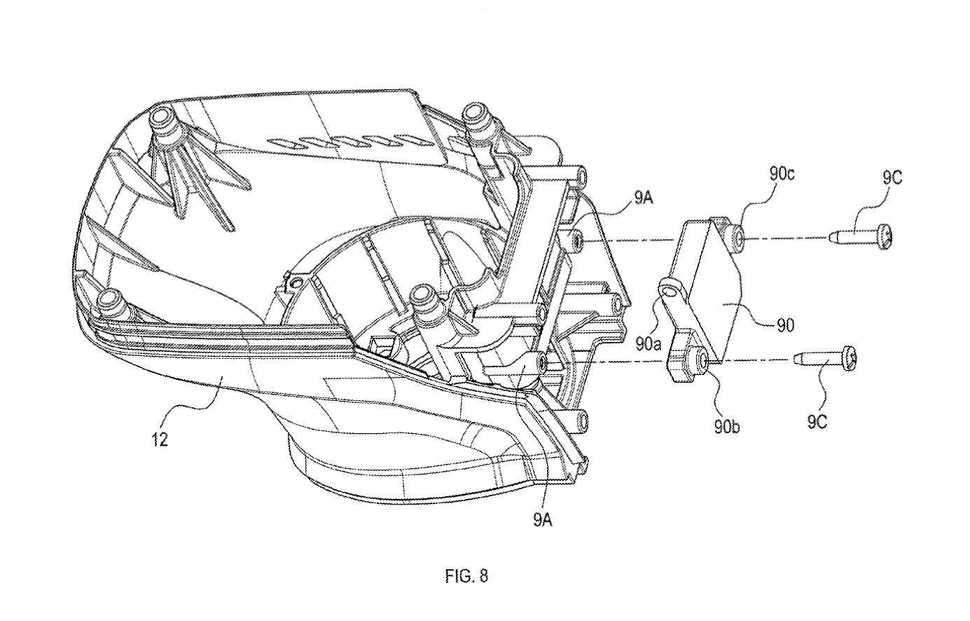

As shown in FIG. 8, the motor-housing 12 in the hammer drill 2A includes a tubular shape so that the motor 8 can be inserted therethrough. The twisted-motion detector 90 is directly fixed to the supporting rods 9A that protrude from the rear wall of the motor-housing 12, with screws 9C, through the attachments 90b and 90c, which are respectively on the left side and right side of the twisted-motion detector 90.

Accordingly, the twisted-motion detector 90 is rigidly coupled to the main housing 10 and disposed in the vibrating section. The vibration of the main housing 10 is thus directly transmitted to the twisted-motion detector 90, which is then enabled to precisely detect the loaded state of the tool bit 4 from the transmitted vibration.

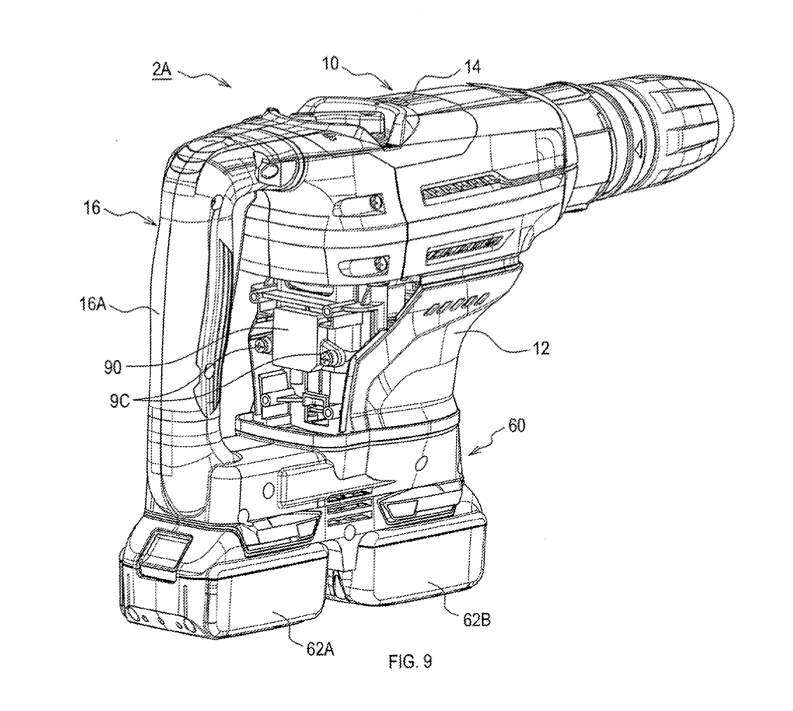

This configuration can facilitate attachment and maintenance of the twisted-motion detector 90, since a rear-side cover of the motor-housing 12 can be removed and the twisted-motion detector 90 can be fixed with screws to the motor-housing 12 from the rear side, as shown in FIG. 9.

As shown in FIG. 7, the motor controller 70 is disposed above the battery port 60 similar to the aforementioned embodiment. Since the battery port 60 is disposed in the vibration-insulated section, the vibration received by the motor controller 70 can be further reduced.

If a load detector is configured independently from the twisted-motion detector 90, then the twisted-motion detector 90 may be disposed above the battery port 60, as shown in a dotted line in FIG. 7, similarly to the motor controller 70.

This configuration places the twisted-motion detector 90 in the vibration-insulated section and thus can protect the twisted-motion detector 90 from vibration. Since the twisted-motion detector 90 is disposed to be spaced apart from the output shaft, it can detect a rotational movement about the output shaft more precisely.

If the twisted-motion detector 90 and the load detector are configured independently from each other, each of these detectors may be configured with an acceleration sensor 92, and an acceleration-detection circuit 94, similarly to the configuration of the twisted-motion detector 90 as shown in FIG. 4. The twisted-motion detector 90 performs the twisted-motion detection process; and the load detector performs the acceleration-load detection process.

The inner structure of the hammer drill 2A shown in FIG. 7 is slightly different from the inner structure of the hammer drill 2 shown in FIG. 1, but similar to the structure disclosed in the aforementioned JP2004518551. Thus, its detailed explanation is omitted herein.

In the aforementioned embodiment, all of the accelerations in the three axial directions (that is, along X-axis; Y-axis; and Z-axis), detected by the acceleration sensor 92, is used in the acceleration-load detection process. In the present disclosure, a load on the tool bit 4 due to the hammering motion can be detected by only using at least the acceleration along the Z-axis.

In the aforementioned embodiment, an example was given with respect to the hammer drill 2 that moves in a rotational motion and a hammering motion. Nevertheless, the present disclosure may be used for an electric power tool that performs a drilling work or a screw-tightening work through a rotational motion, which is, in other words, an electric power tool that does not function as a load detector.

In addition, two or more functions of one element in the aforementioned embodiment may be achieved by two or more elements, or one function of one element in the aforementioned embodiment may be achieved by two or more elements. Likewise, two or more functions of two or more elements may be achieved by one element, or one function achieved by two or more elements may be achieved by one element. A part of the configuration of the aforementioned embodiment may be omitted; and at least a part of the configuration of the aforementioned embodiment may be added to or replaced with another part of the configuration of the aforementioned embodiment. It should be noted that any and all modes that are encompassed in the technical ideas that are defined only by the languages in the scope of the claims are embodiments of the present disclosure.

What is claimed is:

1. An electric power tool comprising:
a housing;
a motor that is housed in the housing;
an output shaft that is housed in the housing, and includes a first end for attachment to a tool bit;
a rotation transmission that is housed in the housing and configured to transmit a rotation of the motor to the output shaft to rotate the output shaft in a circumferential direction of the output shaft;
a motor controller that is housed in the housing and configured to control drive of the motor in accordance with a command, inputted from outside the housing; and
a twisted-motion detector that is disposed in the housing independently from the motor controller, the twisted-motion detector being configured to detect a twisted-motion of the housing in the circumferential direction of the output shaft, and the twisted-motion detector being further configured to output a result of the detection to the motor controller.

2. The electric power tool according to claim 1,
wherein the twisted-motion detector is disposed in the housing, in a given location where acceleration occurs due to the twisted-motion of the housing.

3. The electric power tool according to claim 2,
wherein the given location is spaced apart from the output shaft.

4. The electric power tool according to claim 1, further comprising
a handle that is configured to be grasped by a user of the electric power tool and disposed in a first end of the housing, the first end of the housing being situated opposite the first end of the output shaft in an axial direction of the output shaft; and
a battery port for attachment to a battery, the battery port being disposed in the housing such that the motor is situated in the housing between the battery port and the output shaft, and the battery being configured to supply electric power for the motor,
wherein the motor controller is disposed between the battery port and the handle.

5. The electric power tool according to claim 1, further comprising
a hammer part that is housed in the housing, and configured to move the tool bit, attached to the output shaft, in a reciprocating motion in the axial direction of the output shaft through a rotation of the motor, and to cause the tool bit to hammer on a workpiece; and
a load detector that is configured to detect, based on a vibration of the housing, a load applied from the workpiece to the tool bit due to a hammering motion of the hammer part, the load detector being further configured to output a result of the detection to the motor controller;
wherein the load detector is configured integrally with the twisted-motion detector.

6. The electric power tool according to claim 1, further comprising
a hammer part that is housed in the housing, and configured to move the tool bit, attached to the output shaft, in a reciprocating motion in the axial direction of the output shaft through a rotation of the motor, and to cause the tool bit to hammer on a workpiece; and
a load detector that is configured to detect, based on a vibration of the housing, a load applied from the workpiece to the tool bit due to a hammering motion of the hammer part, the load detector being further configured to output a result of the detection to the motor controller;
wherein the load detector is disposed in the housing independently and separately from the twisted-motion detector.

7. The electric power tool according to claim 5,
wherein the housing includes
a vibrating section that houses the hammer part and vibrates in response to drive of the motor; and
a vibration-insulated section that receives a reduced vibration transmitted from the vibrating section,
wherein the load detector is disposed in the vibrating section.

8. The electric power tool according to claim 7,
wherein the load detector is rigidly coupled to the housing, in the vibrating section.

9. The electric power tool according to claim 7,
wherein the load detector includes a casing having a shape that determines an assembly orientation of the load detector relative to the housing.

10. The electric power tool according to claim 7,
wherein the vibrating section includes a first side, the first side being situated opposite, across the motor, a side where the output shaft is disposed, and
wherein the load detector is disposed in the first side in the vibrating section.

11. The electric power tool according to claim 7,
wherein the vibrating section includes a second side, the second side being situated opposite, across the motor, a side where the first end of the output shaft is disposed, and
wherein the load detector is disposed in the second side in the vibrating section.

12. The electric power tool according to claim 6,
wherein the housing includes
a vibrating section that houses the hammer part and vibrates in response to drive of the motor; and
a vibration-insulated section that receives a reduced vibration transmitted from the vibrating section,
wherein the load detector is disposed in the vibrating section.

13. The electric power tool according to claim 12,
wherein the load detector is rigidly coupled to the housing, in the vibrating section.

14. The electric power tool according to claim 12,
wherein the load detector includes a casing having a shape that determines an assembly orientation of the load detector relative to the housing.

15. The electric power tool according to claim 12,
wherein the vibrating section includes a first side, the first side being situated opposite, across the motor, a side where the output shaft is disposed, and
wherein the load detector is disposed in the first side in the vibrating section.

16. The electric power tool according to claim 12,
wherein the vibrating section includes a second side, the second side being situated opposite, across the motor, a side where the first end of the output shaft is disposed, and
wherein the load detector is disposed in the second side in the vibrating section.

17. The electric power tool according to claim 1, further comprising
a hammer part that is housed in the housing and configured to move the tool bit, attached to the output shaft, in a reciprocating motion in an axial direction of the output shaft through a rotation of the motor, and to cause the tool bit to hammer on a workpiece; and
a load detector that is configured to detect, based on a vibration of the housing, a load applied from the workpiece to the tool bit due to a hammering motion of the hammer part, the load detector being further configured to output a result of the detection to the motor controller,
wherein the housing includes a vibrating section that houses the hammer part and vibrates in response to drive of the motor, and a vibration-insulated section that receives a reduced vibration transmitted from the vibrating section,
wherein the load detector is disposed in the housing independently and separately from the twisted-motion detector and is situated in the vibrating section; and
wherein the twisted-motion detector is disposed in the vibration-insulated section.

18. A method of assembling an electric power tool, the method comprising:
housing a motor in a housing in the electric power tool;
housing an output shaft in the housing, the output shaft including a first end for attachment to a tool bit;
housing a rotation transmission in the housing, the rotation transmission being configured to transmit a rotation of the motor to the output shaft to rotate the output shaft in a circumferential direction of the output shaft;
housing the motor controller in the housing, the motor controller being configured to control drive of the motor in accordance with a command, inputted from outside the housing; and
disposing a twisted-motion detector in the housing independently from the motor controller, the twisted-motion detector being configured to detect a twisted-motion of the housing in the circumferential direction of the output shaft, and the twisted-motion detector further being configured to output a result of the detection to the motor controller.
